(19) United States
(12) Patent Application Publication
(10) Pub. No.: US 2008/0284926 A1
(43) Pub. Date: Nov. 20, 2008

(54) Liquid Crystal Display Device

(75) Inventor: Takashi Akiyama, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN WATCH CO., LTD., Tokyo (JP)

(21) Appl. No.: 11/662,794

(22) PCT Filed: Sep. 15, 2005
(86) PCT No.: PCT/JP05/17060

§ 371 Date: Mar. 14, 2007

(30) Foreign Application Priority Data
Sep. 15, 2004 (JP) 2004-267690

(51) Int. Cl. G09G 3/36

(52) U.S. Cl. 349/36

(57) ABSTRACT

A liquid crystal display device is provided with a liquid crystal display panel (1) composed of a liquid crystal display part having no color filter, and a backlight unit having a light source which can emit light of a plurality of colors. The liquid crystal display device is also provided with a first driving circuit (2), which permits the light source to successively emit light of a plurality of colors in a prescribed cycle, and applies a driving voltage to the liquid crystal of each pixel of the liquid crystal display part, in synchronization with the emission timing so as to perform color display; a second driving circuit (3), which stops emission from the light source or permits the light source to emit only light of one wavelength, applies a driving voltage to the liquid crystal of each pixel of the liquid crystal display part in a longer cycle than the prescribed cycle for black-and-white display or monocolor display; and a drive selecting means (4), which selects to operate either the first driving circuit (2) or the second driving circuit (3). The absolute value of the driving voltage of the second driving circuit (3) is permitted to be smaller than the driving voltage of the first driving circuit (2).

### TECHNICAL FIELD

The present invention relates to a liquid crystal display device capable of both color display and black-and-white display by one liquid crystal panel for use in portable equipment using a battery as its power supply, such as a cellular phone.

### BACKGROUND TECHNOLOGY

In recent years, a liquid crystal display device capable of color display is increasingly used for portable equipment using a battery as its power supply, such as a cellular phone.

A problem with such equipment is the battery life, and the problem of difficulty of a reduction in power consumption in order to increase the battery life could not be solved in a color liquid crystal display device using a color filter because about ⅔ of light from the backlight is absorbed by the color filter.

Hence, a color liquid crystal display device in a field sequential color (hereinafter, abbreviated to “FSC”) mode has been devised.

This technology is to perform color display by permitting light source to sequentially emit a plurality of light with different wavelengths in a predetermined cycle, and applying driving voltages to the liquid crystal in synchronization with the light emission timings of the light source as described in. Patent Document 1. Therefore, there are advantages in that no color filter is required and that high definition can be realized because a pixel does not need to be divided for each of colors of the color filter. Accordingly, the FSC mode is increasingly recognized as a display mode of the color liquid crystal display device suitable for the portable equipment.

FIG. 15 is a time chart showing the difference between the FSC drive and drive of the color liquid crystal display panel with a color filter (hereinafter, abbreviated to a “NML drive”). In the chart, a symbol K denotes the line number of a gate line (gate scanning electrode).

In FIG. 15, tL is a cycle of one field, and two fields constitute one frame (displaying one screen).

The “FSC drive” shown in an upper portion of FIG. 15 is an example of the FSC drive of sequentially emitting light of three primary colors of red (R), green (G), and blue (B), in which one field cycle tL is divided into three subfields, that is, a red subfield tR, a green subfield tC, and a blue subfield tB.

Further, each subfield is composed of, as shown in the chart, a write period twr to write display data into the liquid crystal display part of the liquid crystal display panel, a response waiting period twa to wait for response by the liquid crystal display part, and a lighting period tli to permit the light source of the backlight to emit light of that color.

In the FSC drive, a gate selection signal selects each gate line during the write period twr of the red subfield tR and writes display data for read into the liquid crystal display part, and after waiting for the response waiting period twa being the time of the liquid crystal responding to the data, the red backlight R is turned on at a timing of ON shown at “R” of the “backlight FSC” in a lower portion of FIG. 15 during the lighting period tli. Similarly, a gate selection signal selects each gate line during the write period twr of the green subfield tG and writes display data for green into the liquid crystal display part, and after waiting for the response waiting period twa being the time of the liquid crystal responding to the data, the green backlight G is turned on at a timing of ON shown at “G” of the “backlight FSC” during the lighting period tli. Further, a gate selection signal selects each gate line during the write period twr of the blue subfield tB and writes display data for blue into the liquid crystal display part, and after waiting for the response waiting period twa being the time of the liquid crystal responding to the data, the blue backlight B is turned on at a timing of ON shown at “B” of the “backlight FSC” during the lighting period tli.

In the NML drive that is drive by the color liquid crystal display panel with a color filter, also in the drive of the black-and-white display, each gate line is selected over one field period tL as shown at the “NML drive” in a middle portion of FIG. 15, and a white backlight is turned on (ON) during that period as shown at the “backlight NML” in the lower portion of FIG. 15. Further, one pixel is divided into three portions provided with red, green, and blue color filters, and therefore the pixel capacitance of each pixel is ⅓.

A problem arising in the FSC drive here is that only a short time can be committed for writing though the capacitance value of each pixel of the liquid crystal is three times as large as that in the case of NML drive.

More specifically, the color liquid crystal display device using a color filter is constructed such that one pixel of the liquid crystal display panel is typically divided into three parts so that color filters of three primary colors are assigned to them, and the same gate selection signal is applied to active elements provided in the respective three-divided pixels so that the gate lines in a group are sequentially selected in one field period.

On the other hand, in the case of the liquid crystal display device by the FSC drive, one pixel of the liquid crystal display panel is not divided, but one field is usually divided in terms of time into three subfields corresponding to three primary colors, and only a period of about ⅓ during one subfield period is used for writing display data.

Accordingly, the gate lines in a group are sequentially selected in one subfield period and are each sequentially selected three times in one field, so that the driving frequency of the liquid crystal display device is three times that in the case of the NML drive and the time for selecting each line of the liquid crystal is approximately 1/9 thereof.

As a result, since the pixel capacitance is three times and the selection time is 1/9, the amount of current per unit time for charging the pixel capacitance of the liquid crystal will result in 27 times that in the case of the NML drive.

However, there is a very substantial need for a reduction in power consumption of the cellular phone and the like, and it is not allowed to perform, for example, color display with a large power consumption also during the standby time for receiving and transmitting of the cellular phone. Hence, a mode is proposed which reduces the power consumption by performing color display during use of the cellular phone and performing black-and-white display, for example, during standby time displaying time of day.

Many technologies of performing both the color display and the black-and-white display in one liquid crystal display device are proposed. One of them is a mode when receiving TV broadcast, which proposes that a color burst signal is detected to determine whether color broadcast or black-and-white broadcast, so that when receiving the color broadcast, the voltage to be applied to the liquid crystal display panel is varied within a range required for the color display, while when receiving the black-and-white broadcast, the voltage to be applied is varied within a range required for the black-and-white display (see, for example, Patent Document 2).

This technology is based on the assumption that, generally in the TV image, the proportion of pixels included in a middle gradation region or lower is relatively small during the color display, and the proportion of pixels included in a middle gradation region or lower is relatively large during the black-and-white display, and its effect is to omit the labor of complex brightness adjustment.

However, there is no color burst signal in the image data used in the portable equipment such as a cellular phone. Further, display with middle gradation may not be required for a reduction in power consumption during the black-and-white display, and therefore the technology for the portable equipment is conceivable to be a technology in a field completely different both in image configuration and effect from that for the TV receiver. Further, since the difference between the liquid crystal driving voltage most suitable for the color display and the liquid crystal driving voltage most suitable for the black-and-white display is small, the above-described technology brings about little or no effect in terms of reduction in power even if the technology could be employed.

There is another proposal that, in equipment using a battery as a power supply, the battery voltage is detected so that when the battery voltage is higher than a reference value, a processing signal for performing the color display and a voltage required therefor are supplied to a liquid crystal driver, whereas when the battery voltage is lower than the reference value, a processing signal for limiting display to the black-and-white display and a voltage required therefor are supplied to the liquid crystal driver (see, for example, Patent Document 3).

However, it is not allowed to perform the black-and-white display in the cellular phone except for standby time. In addition, there is no description in Patent Document 3 about a concrete measure of reducing the power consumption during the black-and-white display.

To reduce the power consumption during the black-and-white display, it is proposed, for example, in Patent Document 4 to switch the driving method so as to perform display in single color with two gradations during reception standby time for reduction in power consumption and to perform color display by the FSC drive during use, in a portable information device. This is intended to decrease the number of bits of the display data to be used during the black-and-white display to reduce the driving frequency so as to reduce the power consumption.

However, a small value of 2 mW or less that is the requirement of the power consumption during standby time in the cellular phone cannot be coped only with the method of decreasing the driving frequency.
Patent Document 1: JP H5-19257A
Patent Document 2: JP H11-122628A
Patent Document 3: JP 2002-182604A
Patent Document 4: WO 01/091098A

### DISCLOSURE OF THE INVENTION

### Problems to be Solved by the Invention

As described above, various proposals have conventionally been made on the reduction in power consumption in a liquid crystal display device capable of color display, but those proposals are still insufficient to reduce the power consumption of the liquid crystal display device during standby time.

The invention has been developed in such a background, and it is an object to further reduce the power consumption of the liquid crystal display device which is capable of both of color display and black-and-white display or monocolor display.

### Means to Solve the Problem

To achieve the object, the liquid crystal display device according to the invention is a liquid crystal display device for forming a predetermined image on one screen by sequentially selecting a plurality of scanning lines and applying a voltage to a liquid crystal, wherein the frequency for selecting the scanning line has at least two frequencies, the frequencies being a high frequency and a frequency lower than the high frequency, and wherein a voltage applied to the liquid crystal at the low frequency is made lower than a voltage applied to the liquid crystal at the high frequency.

Further, it is preferable that both of a first drive and a second drive are selectable, the first drive performing color display by applying driving voltages to the liquid crystal in synchronization with light emission timings of light source for sequentially emitting a plurality of light with different wavelengths in a predetermined cycle, and the second drive performing display by stopping the light emission by the light source or permitting the light source to emit only light of one wavelength to apply a driving voltage to the liquid crystal in a predetermined cycle, and that the first drive is at the high frequency and the second drive is at the low frequency.

Further, the liquid crystal display device according to the invention preferably includes: a liquid crystal display panel including a liquid crystal display part provided with no color filter and a backlight unit having light source capable of emitting light of a plurality of colors with different wavelengths;

a first driving circuit for performing color display by permitting the light source of the liquid crystal display panel to sequentially emit the light of the plurality of colors with different wavelengths in a predetermined cycle, and applying a driving voltage to a liquid crystal of each pixel of the liquid crystal display part in synchronization with the light emission timings;

a second driving circuit for performing black-and-white display or monocolor display by stopping the light emission by the light source or permitting the light source to emit only light of one wavelength to apply a driving voltage to the liquid crystal in each pixel of the liquid crystal display part in a cycle longer than the predetermined cycle; and

a drive selecting means for selecting and operating any one of the first driving circuit and the second driving circuit.

In addition, the driving voltage by the second driving circuit is made smaller in absolute value than the driving voltage by the first driving circuit.

It is preferable that the first driving circuit is a circuit for performing field sequential color (FSC) drive.

It is preferable that the time of application of the driving voltage to each pixel of the liquid crystal display part by the second driving circuit is made longer than the time of application of the driving voltage to each pixel of the liquid crystal display part by the first driving circuit.

It is possible that during the FSC drive by the first driving circuit, one field of display by the liquid crystal display panel is divided at least into subfields corresponding to the number of colors of light emitted by the light source, and driving voltages according to display data for different colors are sequentially applied to each pixel of the liquid crystal display part for each of the subfields, and that during the drive by the second driving circuit, a driving voltage according to display data is applied to each pixel of the liquid crystal display part only during a period corresponding to one subfield of the subfields to increase the cycle of application of the driving voltage or the application cycle and application time.

It is also possible that during the FSC drive by the first driving circuit, one field of display by the liquid crystal display panel is divided at least into subfields corresponding to the number of colors of light emitted by the light source, and each of the subfields is further divided into a write period to write display data into the liquid crystal display part, a response waiting period to wait for response by the liquid crystal display part, and a lighting period to permit the light source to emit light of a color corresponding to each subfield, and driving voltages according to display data for different colors are sequentially applied to each pixel of the liquid crystal display part only during each write period for each subfield, and that during the drive by the second driving circuit, a driving voltage according to display data is applied to each pixel of the liquid crystal display part only during a period corresponding to the write period of one subfield of the subfields to increase the cycle of application of the driving voltage.

Further, it is possible that during the FSC drive by the first driving circuit, one field of display by the liquid crystal display panel is divided into subfields corresponding to the number of colors of light emitted by the light source, and driving voltages according to display data for different colors are sequentially applied to each pixel of the liquid crystal display part for each of the subfields, and that during the drive by the second driving circuit, a driving voltage according to display data is applied to each pixel of the liquid crystal display part over a plurality of the divided subfield periods to increase the cycle and time of application of the driving voltage.

In these liquid crystal display devices, the display data generating the driving voltage during the drive by the second driving circuit can be data corresponding to the most significant bit of the color corresponding to the selected subfield or a specific color.

It is preferable that the color corresponding to the selected subfield or the specific color is green.

It is preferable that the first driving circuit is provided with a multi-gradation signal generating circuit for three gradations or more, and during the FSC drive, the driving voltage generated by the multi-gradation signal generating circuit according to display data is applied to each pixel of the liquid crystal display part, and that the second driving circuit is provided with a two-gradation signal generating circuit, and during the drive by the second driving circuit, the multi-gradation signal generating circuit is stopped, and the driving voltage generated by the two-gradation signal generating circuit is applied to each pixel of the liquid crystal display part.

It is preferable that the absolute value of the driving voltage generated by the two-gradation signal generating circuit is made smaller than the absolute value of the driving voltage generated by the multi-gradation signal generating circuit.

It is preferable that a color driving voltage generating part and a black-and-white driving voltage generating part are provided so that an output voltage of the color driving voltage generating part is supplied to the multi-gradation signal generating circuit, and an output voltage of the black-and-white driving voltage generating part is supplied to the two-gradation signal generating circuit, and wherein the output voltage of the black-and-white driving voltage generating part is set smaller in absolute value than the output voltage of the color driving voltage generating part.

The driving voltage by the second driving circuit can be made smaller by 15% to 70% in absolute value than the driving voltage by the first driving circuit.

### BRIEF DESCRIPTION OF DRAWINGS

FIG. 1 is a block diagram showing the basic configuration of a liquid crystal display device according to the invention;

FIG. 2 is a schematic cross-sectional view showing a configuration example of the liquid crystal display panel for use in the invention;

FIG. 3 is a schematic cross-sectional view showing another configuration example of the liquid crystal display panel for use in the invention;

FIG. 4 is a schematic cross-sectional view showing still another configuration example of the liquid crystal display panel for use in the invention;

FIG. 5 is an enlarged plan view of an internal reflecting film in FIG. 4 for one pixel;

FIG. 6 is a schematic sectional view showing a portion of the liquid crystal display part shown in FIG. 2 to FIG. 4 enlarged;

FIG. 7 is a view showing a gate scanning electrode group and a signal electrode group and equivalent circuits of pixels formed on the liquid crystal display part shown in FIG. 2 to FIG. 4;

FIG. 8 is a timing chart showing the liquid crystal panel driving operation according to the first embodiment of the invention;

FIG. 9 is a characteristic diagram showing the relation between the application voltage to a liquid crystal cell and the transmittance;

FIG. 10 is a similar characteristic diagram showing the relation between the application time and the transmittance when the application voltage is varied;

FIG. 11 is a block diagram showing a configuration example of a circuit for generating a driving voltage according to a data signal in the embodiment of the invention;

FIG. 12 is a timing chart showing the liquid crystal panel driving operation according to the second embodiment of the invention;

FIG. 13 is a timing chart showing the liquid crystal panel driving operation according to the third embodiment of the invention;

FIG. 14 is a waveform diagram showing a response example of a liquid crystal pixel by FSC drive and the NML drive; and

FIG. 15 is a timing chart showing the difference in drive between a color liquid crystal display device by the FSC drive and a color liquid crystal display device with a color filter.

### REFERENCE OF NUMERALS

1 liquid crystal display panel
2 first driving circuit (FSC driving circuit)
3 second driving circuit
4 drive selecting means
10 liquid crystal display part
12 polarizing plate
13 display electrode (pixel electrode)
14 upper transparent substrate
15 sealing material
16 liquid crystal layer
17 common electrode
18 lower transparent substrate
20 polarizing plate
21 backlight unit
22 light guide plate
24 light source
26 transflective reflecting plate
28 reflecting layer
30 internal reflecting layer (also serving as common electrode)
32 light transmission part
42 thin film transistor (TFT)
43 pixel region
44 capacitor (storage capacitance)
46 capacitor (pixel capacitance)
48 signal electrode group
50 gate scanning electrode group
70 pixel memory
71 boosting circuit
72 multi-gradation signal generating circuit
73 color driving voltage generating part
74 two-gradation signal generating circuit
75 black-and-white driving voltage generating part
76 switch means
77 gradation selecting circuit group
tL1, tL2 field
tR1, tG1, tB1, tR2, tG2, tB2 subfield
twr write period twa response waiting period tli lighting period
tG1, tG2 green subfield

### BEST MODE FOR CARRYING OUT THE INVENTION

Hereinafter, embodiments of the invention will be described with reference to the accompanying drawings.

FIG. 1 is a block diagram showing the basic configuration of a liquid crystal display device according to the invention.

The liquid crystal display device comprises a liquid crystal display panel 1, a first driving circuit 2 and a second driving circuit 3 for driving the liquid crystal display panel 1, and a drive selecting means 4 for selecting and operating one of the circuits 2 and 3.

The liquid crystal display panel 1 comprises a liquid crystal display part provided with no color filter and a backlight unit having light source capable of emitting light of a plurality of colors with difference wavelengths. Their specific configuration examples will be described later.

The first driving circuit 2 is a circuit for permitting the light source of the liquid crystal display panel 1 to sequentially emit light of a plurality of colors with different wavelengths in a predetermined cycle, and applying driving voltages to the liquid crystal of each pixel in the liquid crystal display part in synchronization with the light emission timings so as to perform color display. Preferably, a circuit for performing field sequential color (FSC) drive is used as the first driving circuit.

The second driving circuit is a circuit for stopping the light emission by the light source of the liquid crystal display panel 1 or permitting the light source to emit only light of one wavelength, and applying a driving voltage to the liquid crystal of each pixel in the liquid crystal display part in a cycle longer than the above-described predetermined cycle so as to perform black-and-white display or monocolor display.

In addition, the absolute value of the driving voltage by the second driving circuit 3 is made smaller than the driving voltage by the first driving circuit 2. The details will be described later.

The drive selecting means 4 brings, for example, the first driving circuit 2 into operation and the second driving circuit 3 into non-operation when electronic equipment such as a cellular phone incorporating the liquid crystal display device is in a usage state, while bringing the second driving circuit 3 into operation and the first driving circuit 2 into non-operation when the electronic equipment is in a standby state.

Note that the first driving circuit 2 and the second driving circuit 3 can be provided as completely separate circuits but are not limited to that arrangement, and portions thereof can be shared, or a portion of the first driving circuit 2 can be used as the second driving circuit 3.

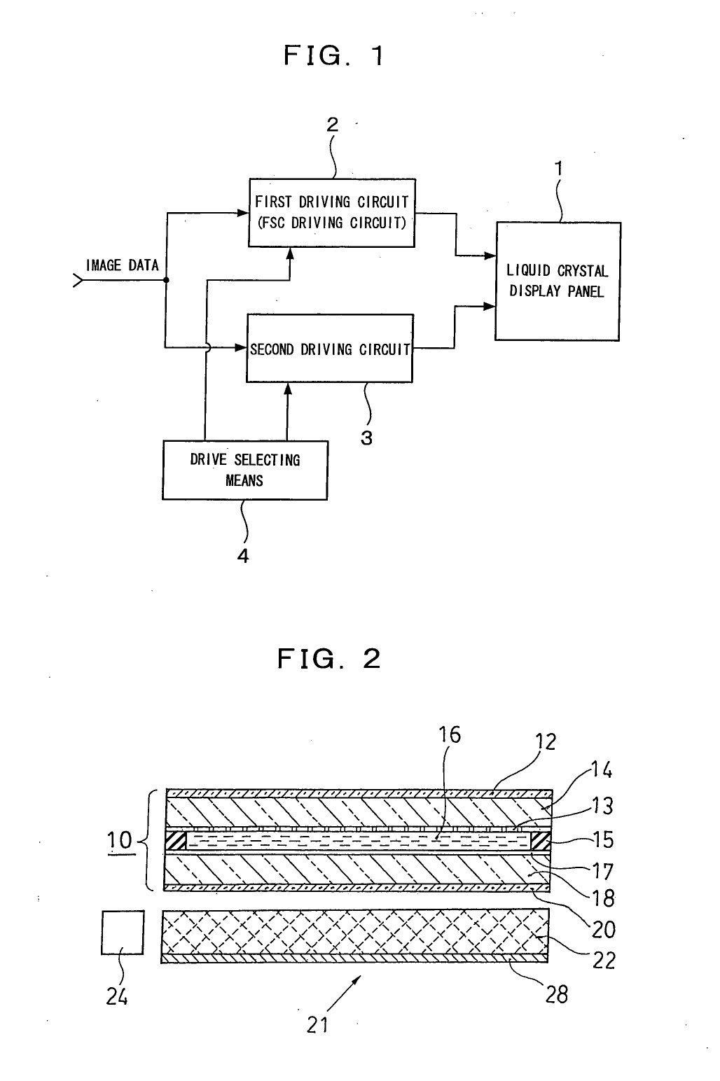

Next, the configuration of the above-described liquid crystal display panel 1 will be described with reference to FIG. 2 to FIG. 7. FIG. 2 is a schematic cross-sectional view showing a configuration example of the liquid crystal display panel for use in the invention.

In FIG. 2, an upper transparent substrate 14 and a lower transparent substrate 18 each made of transparent glass or resin are bonded together with a sealing material 15 with a predetermined space intervening therebetween, a liquid crystal layer 16 is sealed and held in the space, and a polarizing plate 12 and a polarizing plate 20 are bonded to an upper surface of the upper transparent substrate 14 and a lower surface of the lower transparent substrate 18, respectively, to form a liquid crystal display part 10.

On an inner surface of the upper transparent substrate 14 (surface on the liquid crystal layer 16 side), a display electrode (pixel electrode) 13 and a thin film transistor (TFT) for each pixel region, a gate scanning electrode group and a signal electrode group which are not shown in FIG. 2 are provided. Those details will be described later. On an inner surface of the lower transparent substrate 18 (surface on the liquid crystal layer 16 side), a common electrode 17 is formed on the entire surface. Each of the display electrode 13 and the common electrode 17 is a transparent conductive film such as indium tin oxide (ITO).

Portions where the display electrodes 13 and the common electrode 17 are opposed constitute pixels in a dot matrix form. Note that on the surface of each of the display electrodes 13 and the common electrode 17, an alignment film is formed for aligning molecules of the liquid crystal layer 16 in a fixed direction, but illustration thereof is omitted.

The liquid crystal layer 16, which comprises, for example, a twisted nematic (TN) liquid crystal, has optical rotatory power where no voltage is applied between the display electrode 13 and the common electrode 17 to rotate the polarization direction of the linearly polarized light transmitted through the liquid crystal layer 16 by 90°, while losing the optical rotatory power where a predetermined voltage is applied between the display electrode 13 and the common electrode 17 to transmit the linearly polarized light as it is.

Each of the polarizing plate 12 and the polarizing plate 20 is a typical absorption-type polarizing plate that transmits a linearly polarized light with a polarization direction parallel to the transmission axis and absorbs a linearly polarized light with a polarization direction orthogonal to the transmission axis, and the polarizing plates 12 and 20 are arranged such that their transmission axes are orthogonal or parallel to each other.

Therefore, the transmittance of each pixel changes depending on the presence or absence and the magnitude of a voltage to be applied between the display electrode 13 and the common electrode 17 to function as a shutter. Note that a super twisted nematic (STN) liquid crystal or a ferroelectric liquid crystal can also be used as the liquid crystal layer 16.

Under the lower transparent substrate 18 of the liquid crystal display part 10, a backlight unit 21 is provided which is composed of light source 24 capable of sequentially and repeatedly emitting light of a plurality of colors with different wavelengths, for example, red, green, and blue light; a light guide plate 22 for planarly diffusing the light emitted by the light source 24; and a reflecting layer 28 provided on the lower surface of the light guide plate 22. The light source 24 are composed of, for example, three or more light emitting diodes (LEDs) emitting red, green, and blue light, respectively.

The liquid crystal display part 10 of the liquid crystal display panel is not provided with a color filter. Therefore, it is not necessary to divide each pixel into regions where color filters of three primary colors are arranged.

In the liquid crystal display panel configured as described above, at the time when performing the FSC drive, the backlight unit 21 sequentially emits light of three primary colors to illuminate the liquid crystal display part 10, and the liquid crystal display part 10 functions as a shutter for each pixel as described above according to display data corresponding to each color, thereby performing color display.

During the black-and-white display, the light emission by the light source 24 of the backlight unit 21 is stopped, and the liquid crystal display part 10 functions as a shutter which is binary-driven either into a state to transmit the light or into a state to absorb the light according to the display data for each pixel. The light incident from the viewing side above the upper transparent substrate 14 is transmitted through a pixel portion in the state to transmit the light of the liquid crystal display part 10, transmitted through the light guide plate 22, reaches the reflecting layer 28, reflected by the reflecting layer 28, returned along the same path, transmitted through the liquid crystal display part 10, and returned to the viewing side above the upper transparent substrate 14. In a pixel portion in the state to absorb the light of the liquid crystal display part 10, the light incident from the viewing side is not returned because it is absorbed by the polarizing plate 12 and the polarizing plate 20. In this manner, the liquid crystal display panel functions as a reflection-type black-and-white display device.

Besides, the liquid crystal display panel functions as a transmission-type monocolor display device by permitting the light source 24 of the backlight unit 21 to emit light of only one color and binary-driving each pixel of the liquid crystal display part 10 as in the above-described case.

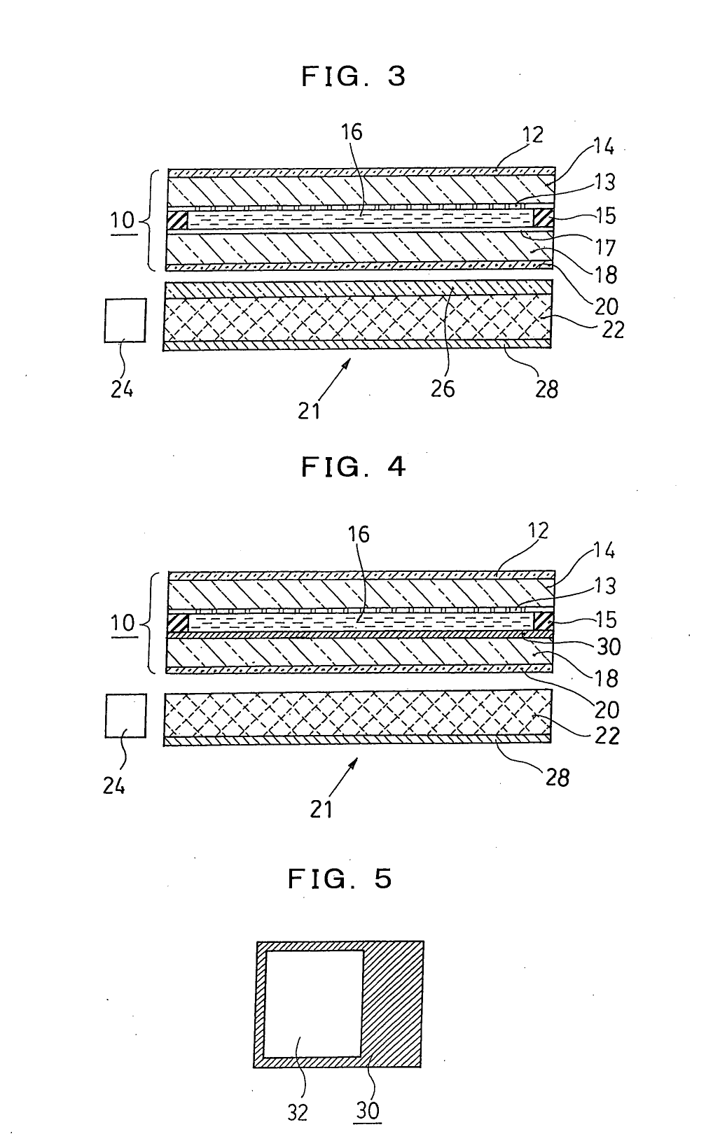

FIG. 3 is a schematic cross-sectional view showing another configuration example of the liquid crystal display panel for use in the invention, in which the same numbers are given to the same portions as those in FIG. 2, and their description will be omitted.

A different point of the liquid crystal display panel shown in FIG. 3 from the liquid crystal display panel shown in FIG. 2 is that a transflective reflecting plate 26 is provided between the lower transparent substrate 18 of the liquid crystal display part 10 and the light guide plate 22 of the backlight unit 21.

Thus, at the time when performing the FSC drive, the backlight unit 21 sequentially emits light of three primary colors, of which the light transmitted through the transflective reflecting plate 26 illuminate the liquid crystal display part 10. During the black-and-white display, a portion of the light incident on the liquid crystal display part 10 from the viewing side and transmitted therethrough and reached the transflective reflecting plate 26 are reflected and returned to the viewing side above the upper transparent substrate 14.

Even this liquid crystal display panel functions as a transmission-type monocolor display device by permitting the light source 24 of the backlight unit 21 to emit light of only one color so as to illuminate the liquid crystal display part 10 with a single color light transmitted through the transflective reflecting plate 26, and binary-driving each pixel.

FIG. 4 is a schematic cross-sectional view showing still another configuration example of the liquid crystal display panel for use in the invention, in which also the same numbers are given here to the same portions as those in FIG. 2, and their description will be omitted.

A different point of the liquid crystal display panel shown in FIG. 4 from the liquid crystal display panel shown in FIG. 2 is that an internal reflecting layer 30 is provided on the lower transparent substrate 18 of the liquid crystal display part 10. In the internal reflecting layer 30, a light transmission part 32 is formed by hollowing a portion of the internal reflecting layer 30 for each pixel as shown in FIG. 5. The internal reflecting layer 30 can also serve as the common electrode 17 if the internal reflecting layer 30 is a conductive reflecting film such as an aluminum thin film or the like. In this case, a transparent conductive film is preferably formed in the light transmission part 32. Alternatively, the common electrode may be formed of a transparent conductive film over the entire region of the internal reflecting layer 30 also including the light transmission part 32.

In the liquid crystal display panel, at the time when performing the FSC drive, the backlight unit 21 sequentially emits light of three primary colors, the backlight illuminate the liquid crystal display part 10, of which the light transmitted through the light transmission part 32 of the internal reflecting layer 30 go out to the viewing side.

During the black-and-white display, external light incident on the liquid crystal display part 10 from the viewing side is reflected by the internal reflecting layer 30 and returned to the viewing side, thereby performing the black-and-white display.

Even this liquid crystal display panel functions as a transmission-type monocolor display device by permitting the light source 24 of the backlight unit 21 to emit light of one only color so as to illuminate the liquid crystal display part 10 with a single color light, permitting the single color light transmitted through the light transmission part 32 of the internal reflecting layer 30 to go out to the viewing side, and binary-driving each pixel.

Note that the internal reflecting layer 30 can be formed concurrently with the formation of a later-described electrode group of TFTs, thus bringing about cost effect.

The liquid crystal display panel for use in the invention is capable of the FSC drive display and the black-and-white reflection display and the transmission-type monocolor display as described above. Note that the liquid crystal display panel usable in the invention is not limited to those of types described using FIG. 2 to FIG. 5, but can be one, capable of both the FSC drive display and the black-and-white reflection display or the monocolor display without providing a color filter.

The liquid crystal display panels shown in FIG. 2 to FIG. 4 are active matrix-type TFT liquid crystal display panels which drive pixels by sequentially switching them by TFTs as described later. However, the liquid crystal display panel is not limited to the above, but a simple matrix-type liquid crystal display panel can also be used in which, in place of the display electrodes 13 and the common electrode 17, transparent scanning electrodes and signal electrodes in stripes perpendicular to each other are formed, and portions where both electrodes intersect and are opposed to each other form pixels.

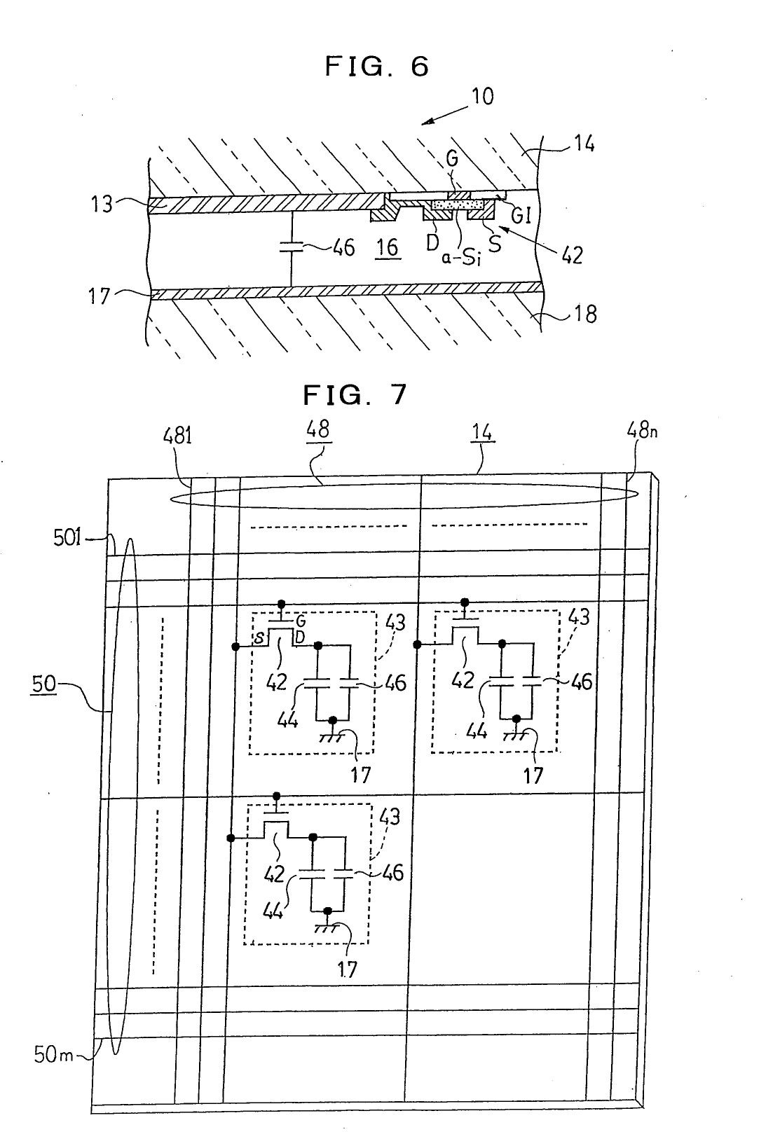

The display electrode and the thin film transistor (TFT) provided for each pixel in the liquid crystal display parts 10 of the liquid crystal display panels shown in FIG. 2 to FIG. 4 will be described now using FIG. 6. FIG. 6 is a schematic sectional view showing a portion of the liquid crystal display part enlarged.

As shown in FIG. 6, the display electrode 13 made of a transparent conductive film is formed for each pixel region on the inner surface of the upper transparent substrate 14, and a TFT 42 is formed adjacent thereto.

Further, a region where the display electrode 13 and the common electrode 17 are opposed to each other with the liquid crystal layer 16 intervening therebetween constitutes a pixel, where a pixel capacitance using the liquid crystal layer 16 as a dielectric exists which is shown by a capacitor 46.

The TFT 42 is composed of a gate electrode G and a gate insulating film GI formed on the upper transparent substrate 14, an amorphous silicon a-Si, and a source electrode S and a drain electrode D formed thereon, the drain electrode D being connected to the display electrode 13.

Further, a storage capacitance using the gate insulating film GI as a dielectric is formed between the upper transparent substrate 14 and a portion of the display electrode 13 and is connected in parallel with the capacitor 46, but this is a well known technology and therefore illustration thereof is omitted here.

Note that the display electrode 13 and the TFT 42 may be formed on the lower transparent substrate 18, and the common electrode 17 may be formed on the upper transparent substrate 14.

Next, a gate scanning electrode group and a signal electrode group and equivalent circuits of pixels formed on the upper transparent substrate 14 of the liquid crystal display part will be described using FIG. 7.

In FIG. 7, on the upper transparent substrate 14, a gate scanning electrode group 50 composed of gate scanning electrodes (scanning lines) 50l to 50m and a signal electrode group 48 composed of signal electrodes (signal lines) 48l to 48n are formed perpendicular to each other such as to partition the matrix of pixel regions 43 shown by broken lines.

The above-described TFT 42 is provided for each pixel region 43, and its drain electrode D is connected to the above-described display electrode 13, its source electrode S is connected to one line of the signal electrode group 48, and its gate electrode G is connected to one line of the gate scanning electrode group 50, respectively. The capacitor 46 being the pixel capacitance shown in FIG. 6 and a capacitor 44 being the previously described storage capacitance are equivalently connected in parallel to form a signal holding capacitance of each pixel, and its one end is connected to the drain electrode D of the TFT 42 and the other end is connected to the common electrode 17 to be supplied with the ground potential.

The gate electrode G of the TFT 42 is connected to one line of the gate scanning electrode group 50 for each row, so that the TFTs 42 in each row are sequentially scanned, that is, selected, whereby the selected TFT 42 is brought into a conduction state to capture display data on one line of the signal electrode group 48 connected to the source electrode S, into the capacitors 44 and 46. The liquid crystal layer 16 of each pixel region 43 is driven according to the voltage captured into the capacitors 44 and 46.

The gate electrodes G of the respective TFTs 42 of a plurality of pixel regions 43 in one row are connected to the same one line of the gate scanning electrode group 50, so that the display data is written into the respective capacitors 44 and 46 by each of the TFTs 42, and the display data (voltage) is held by the capacitors 44 and 46. Thus, the liquid crystal display part of the liquid crystal display panel used in the invention can hold the display state for at least a certain time when the data is written into the pixel. By sequentially selecting the plurality of scanning lines and applying the voltage to the liquid crystal in this manner, a predetermined image can be formed on one screen.

In the drive by the second driving circuit 3 shown in FIG. 1 (referred to as the “NML drive”), the period from the time when the first gate scanning electrode is selected to the time when that electrode is selected next is one field, and in the drive by the first driving circuit 2 (referred to as the “FSC drive”), the first gate scanning electrode is selected the number of times corresponding to the number of colors of emitted light by the light source in one field.

Though not shown, a driving IC constituting the first driving circuit 2 and the second driving circuit 3 may be COG-mounted on the upper transparent substrate 14, or a driving IC mounted on a film may be connected to the signal electrode group 48 and the gate scanning electrode group 50.

Next, the liquid crystal panel driving operation by the above-described liquid crystal display device according to the invention will be described.

### EMBODIMENT 1

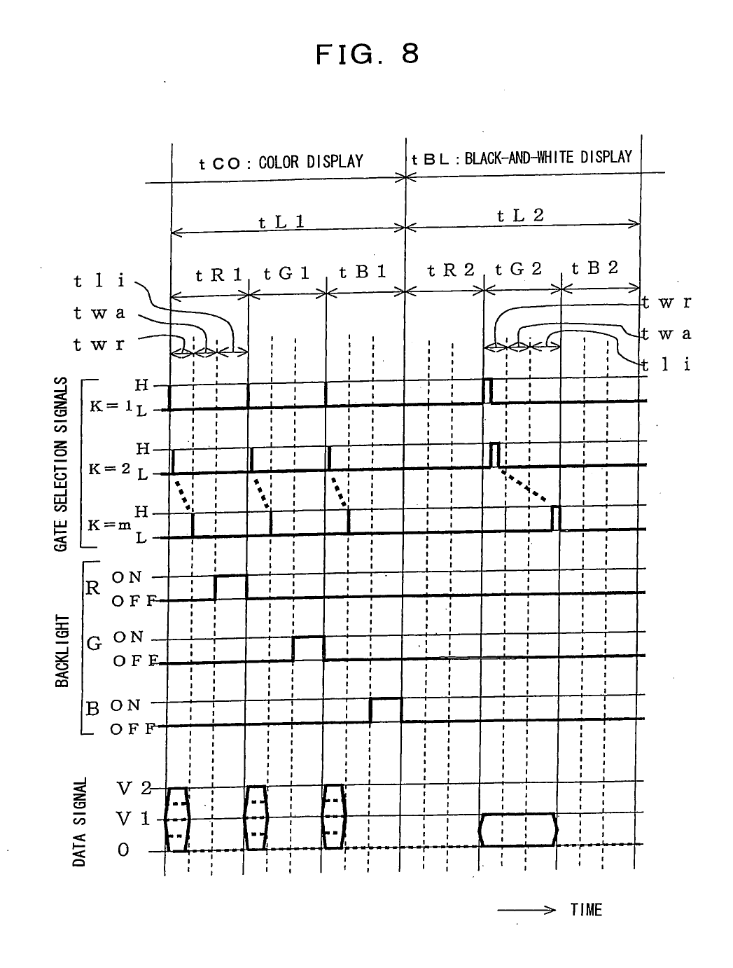

FIG. 8 is a timing chart showing the liquid crystal panel driving operation according to the first embodiment of the invention.

In FIG. 8, tCO represents a color display period and tBL represents a black-and-white display period and tL1 and tL2 are one field period respectively, and each of the fields is divided into a red subfield tR1, tR2, a green subfield tG1, tG2, and a blue subfield tB1, tB2, and each subfield is further divided into a write period twr to write the display data into each pixel of the liquid crystal display part, a response waiting period twa to wait for response by the liquid crystal display part, and a lighting period tli to permit the light source of the backlight unit to emit light of that color (wavelength) as shown in the chart.

In the FSC drive by the first driving circuit 2, gate selection signals select m gate scanning electrodes during the write period twr of the red subfield tR to write the display data for red into the pixels of the liquid crystal display part. A symbol K for the gate selection signal in FIG. 8 represents the line number of the gate scanning electrode. For example, when the gate selection signal represented by K=1 is at H level, the signal selects the uppermost gate scanning electrode 50l shown in FIG. 7, and when the gate selection signal represented by K=m is at H level, the signal selects the lowermost gate scanning electrode 50m shown in FIG. 7.

During the period, a display signal supplied to the signal electrode group 48 shown in FIG. 7 is a voltage signal (corresponding to the previously described “driving voltage”) which may take the voltage between 0 to V2 depending on the gradation as shown at a “data signal” shown in FIG. 8 according to the display data for each row. After waiting for the response waiting period twa being the time of the liquid crystal of the liquid crystal display part responding to the voltage signal, the red backlight R is turned on during the lighting period tli at the timing shown in the chart.

In the similar manner, the gate selection signals select m gate scanning electrodes during the write period twr of the green subfield tG to write the display data for green into the pixels of the liquid crystal display part. During the period, the display signal supplied to the signal electrode group 48 shown in FIG. 7 is a voltage signal which may take the voltage between 0 to V2 depending on the gradation as shown at the “data signal” shown in FIG. 8 according to the display data for each row. After waiting for the response waiting period twa being the time of the liquid crystal of the liquid crystal display part responding to the voltage signal, the green backlight G is turned on during the lighting period tli at the timing shown in the chart.

The gate selection signals select m gate scanning electrodes during the write period twr in the blue subfield tB to write the display data for blue into the pixels of the liquid crystal display part. During the period, the display signal supplied to the signal electrode group 48 shown in FIG. 7 is a voltage signal which may take the voltage between 0 to V2 depending on the gradation as shown at the “data signal” shown in FIG. 8 according to the display data for each row. After waiting for the response waiting period twa being the time of the liquid crystal of the liquid crystal display part responding to the voltage signal, the blue backlight B is turned on during the lighting period tli at the timing shown in the chart.

To repeat the displays in red, green, and blue in a time-division manner for recognition as natural colors, the one field period needs to be 1/60 seconds or less. Accordingly, it is necessary that the one subfield period is 1/180 seconds or less, and the write period twr is 1/540 seconds or less being about one third the subfield period, which is 1.85 mS or less. Accordingly, in the case of a QVGA panel of 320 dots by 240 dots, the number of gate scanning electrode lines is 240, and therefore the selection time of one gate scanning electrode is about 7.7 μS or less, during which the capacitors 44 and 46 shown in FIG. 6 of each pixel need to be charged.

When the equipment is brought into the standby state to bring the display into the black-and-white display state by the second driving circuit 3, all of the backlights “R, G, and B” are brought into a light-out state as shown in the black-and-white display period tBL in FIG. 8, during which the gate scanning electrode group 50 of the liquid crystal display part is selected only in one subfield period and over the entire subfield period. In the example shown in FIG. 8, the gate scanning electrode lines of the gate scanning electrode group 50 are each selected once by the gate selection signals “K=1,” “K=2,” . . . “K=m,” during all the periods through the write period twr, the response waiting period twa, and the lighting period tli of the green subfield tG2.

As a result, the time of one gate scanning electrode is selected is about three times that in the case of the FSC drive. During the period, the display signal supplied to the signal electrode group 48 shown in FIG. 7 is the voltage signal with two gradations taking 0 or V1 as shown at the “data signal” in FIG. 8 according to the display data for each row.

In this embodiment, the green subfield tG2 is selected as one subfield. The reason why the green is selected is that the brightness/darkness of green among the three primary colors is closest to the brightness/darkness of black and white.

Note that the green backlight is turned on with the green subfield tG2 selected, whereby the green monocolor display can be performed. For example, when backlight is required in the standby state, the monocolor display can also be performed by manually turning on the green backlight.

Further, during the FSC drive, the display data (voltage) is written into each pixel of the liquid crystal display part for each subfield to thereby apply a new voltage, whereas during the black-and-white drive, a new voltage is applied for each field, so that the cycle of the voltage application is three times as long as that during the FSC drive.

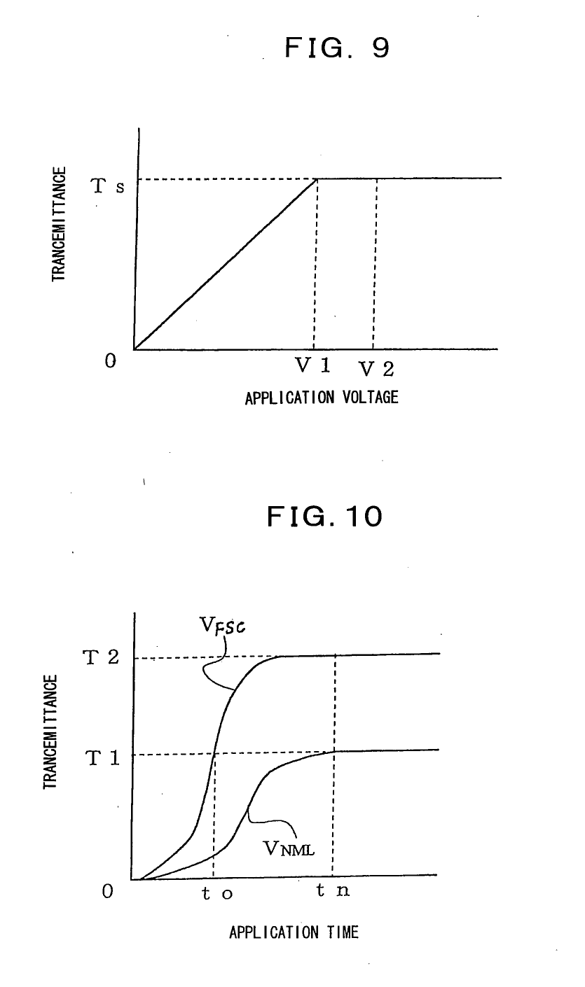

The application voltages V2 and V1 to the liquid crystal display part will be described using FIG. 9.

FIG. 9 is a characteristic diagram showing the relation between the application voltage to the liquid crystal cell and the transmittance, showing the characteristics where the voltage is applied to the liquid crystal of the liquid crystal display part for a sufficiently long time.

In FIG. 9, as the application voltage to the liquid crystal is increased, the transmittance rises so that the transmittance reaches Ts being the saturation value at an application voltage V1. After reaching Ts, the transmittance never varies even when the application voltage is raised. Accordingly, the transmittance remains at Ts also when a voltage V2 greater than V1 is applied.

FIG. 10 is a diagram showing the relation between the time for applying voltage to the TN mode liquid crystal and the transmittance, showing the characteristics when an application voltage V_{NML} is applied during the normal drive (NML drive) and when an application voltage V_{FSC} is applied during the FSC drive.

In FIG. 10, the voltage V_{NML} has been applied in the NML drive to obtain a transmittance T1. A curve shown by V_{NML} is the characteristic when the voltage V_{NML} is applied. As shown in this diagram, for the transmittance of the liquid crystal to reach T1 by applying V_{NML}, it is necessary to continuously apply the voltage V_{NML} during at least a time tn shown. In the FSC drive, since the voltage application time to one pixel, that is, the selection time of one gate scanning electrode is as short as 7.7 μS or less, it is impossible to bring the transmittance of the liquid crystal to T1 during the limited voltage application time even by applying the same voltage V_{NML}. Hence, it is effective to apply a voltage V_{FSC} higher than the voltage V_{NML}.

The curve shown by V_{FSC} in FIG. 10 is characteristics when the voltage V_{FSC} higher than the voltage V_{NML} is applied. By applying the high voltage V_{FSC} to the liquid crystal, the transmittance of the liquid crystal can be brought to T1 in a short time of “to” shown in the figure. Incidentally, the application of the high voltage V_{FSC} to the liquid crystal for a long time will bring the transmittance of the liquid crystal to T2, for example, after a time tn, resulting in failing to display correct gradations on the liquid crystal display part.

Hence, the technology illustrated in Patent Document 6 is also supposed in which the high voltage is applied, for example, only during the first frame and the original gradation voltage is applied from the next frame. However, in the case of the FSC drive, since the time of voltage application to the liquid crystal is short, as well as the voltages according to the display data for the colors of the emitted light by the light source are sequentially rewritten, and the response by the liquid crystal therefore needs to be completed in each sub-frame, it is preferable to constantly and continuously apply the high voltage.

How much voltage needs to be quantitatively applied as the high voltage V_{FSC} can be determined according to parameters such as the capacitance value of the capacitor in each pixel of the liquid crystal display part, the impedance of the drive system, the time of voltage application and so on, and it is desirable to select a voltage such that the time to shown in FIG. 10 is 7.7 μS or less as described above.

Besides, in the case where the liquid crystal display panel using a color filter is driven, the time of voltage application to the liquid crystal and the voltage application cycle are sufficiently long, and therefore a voltage corresponding to the voltage V_{NML} in FIG. 10 is applied to the liquid crystal also during the color display. Therefore, if the voltage applied to the liquid crystal during the back-and-white display is decreased, the transmittance of the liquid crystal cannot be brought into a saturation state, that is, to Ts in FIG. 9, bringing about a problem in display quality. Namely, there is no choice to decrease the driving voltage during the black-and-white drive.

However, the liquid crystal display device according to the invention drives the liquid crystal display part by the voltage V_{FSC}, which is higher than normal, by the FSC drive during the color display, so that the driving voltage can be decreased during the black-and-white drive.

In this embodiment, the voltage V_{FSC} is set to 8V during the FSC drive and the voltage V_{NML} is set to 5V during the black-and-white drive to thereby reduce the driving voltage during the black-and-white drive by the second driving circuit 3 by 38% with respect to the driving voltage during the FSC drive by the first driving circuit 2 so as to significantly reduce the power consumption during the black-and-white drive. Although the value varies depending on the characteristics of the liquid crystal display part and driving parameters of the liquid crystal, the driving voltage during the black-and-white drive can be reduced with respect to the driving voltage during the FSC drive by a range from 15% to 70%.

Returning to FIG. 8, the power is reduced by applying a multi-gradation signal of a highest voltage of V2 to the liquid crystal display part as the data signal during the color display and applying a two-gradation voltage signal of 0 or V1 lower than V2 to the liquid crystal display part during the black- and white display in this embodiment. V1 is a voltage significantly smaller than V2 by 15% to 70% as described above. The relation between the voltages V2 and V1 also applies to the following embodiments.

Further, during the black-and-white display, since the cycle of the voltage application to the liquid crystal display part is three times that during the color display, the charge/discharge current of the liquid crystal, the consumption current of the liquid crystal driving circuit, and so on can also be reduced.

Further, according to this embodiment, the configuration of the field that is the base of display timing is not changed during the color display and the black-and-white display, thus eliminating complexity in the circuit configuration of the drive system to prevent an increase in cost of the driving circuit system.

Note that since the voltage of the data signal is reversed into negative voltages −V1 and −V2 in a field subsequent to the field shown in FIG. 1, the magnitude relation between the voltage V_{FSC} and the voltage V_{NML} will be defined in absolute value, and the voltage V_{NML} is set to a voltage smaller by 15% to 70% in absolute value than the voltage V_{FSC}.

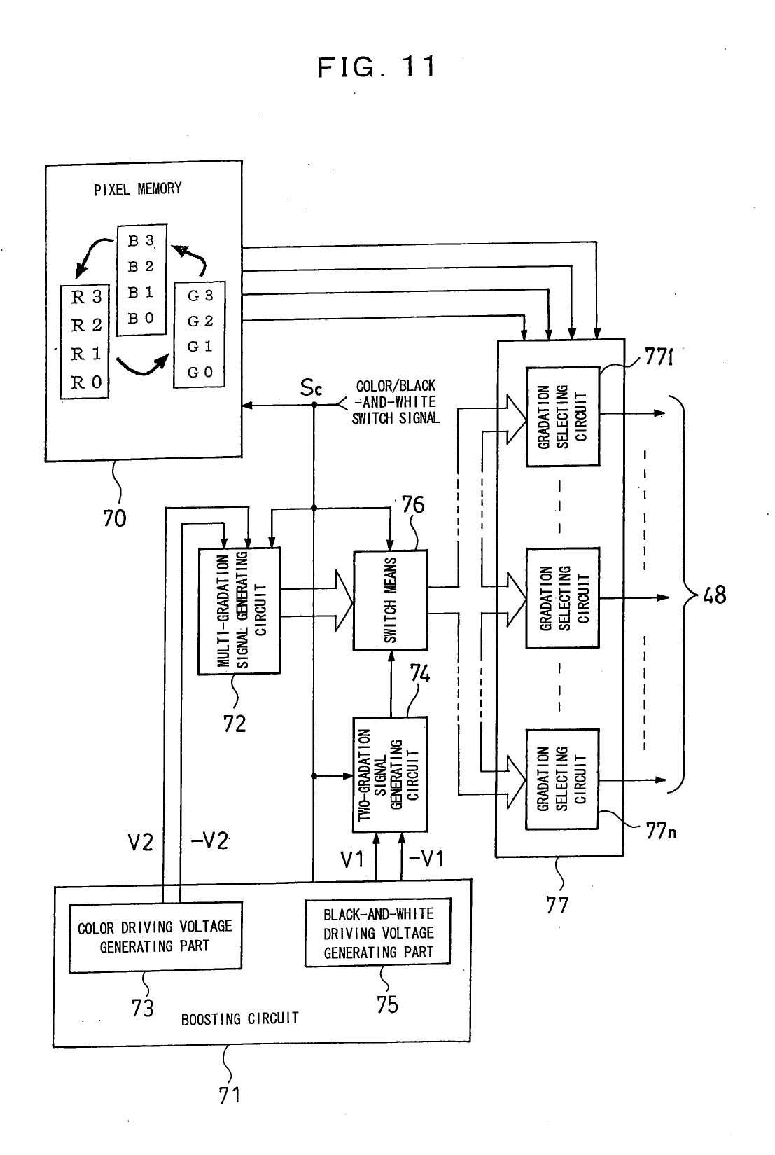

FIG. 11 is a block diagram showing a configuration example of a circuit for generating a driving voltage according to the data signal in this embodiment.

In FIG. 11, during the FSC drive, a multi-gradation signal generating circuit 72 generates a multi-gradation voltage signal with a required number of gradations that is three gradations or more, and inputs the signal into each of gradation selecting circuits 77l to 77n of a gradation selecting circuit group 77 via a switch means 76. On the other hand, an image memory 70 sends display data for each color, each row, and each pixel, individually to each of the gradation selecting circuits 77l to 77n of the gradation selecting circuit group 77 in synchronization with the write period of the subfield period of each color. FIG. 11 shows an example in which the gradation signal to each pixel is composed of four bits.

Each of the gradation selecting circuits 77l to 77n of the gradation selecting circuit group 77 selects the multi-gradation signal inputted via the switch means 76 according to the display data inputted from the image memory 70, and outputs the signal as the data signal (driving voltage).

Though only three of the gradation selecting circuits 77l to 77n of the gradation selecting circuit group 77 are illustrated, there are n gradation selecting circuits in correspondence with the number of signal electrodes 48l to 48n, which is n, of the signal electrode group 48 shown in FIG. 7 of the liquid crystal display part. The data signals (driving voltages) outputted from the gradation selecting circuits 77l to 77n respectively are applied to the signal electrodes 48l to 48n connected thereto in a corresponding manner to perform color display.

During the black-and-white display or during the monocolor display, a two-gradation signal generating circuit 74 generates the two-gradation voltage signal and inputs the signal into each of the gradation selecting circuits 77l to 77n of the gradation selecting circuit group 77 via the switch means 76. On the other hand, the image memory 70 sends only the most significant bit G3 of the display data for green individually to each of the gradation selecting circuits 77l to 77n of the gradation selecting circuit group 77 in synchronization with the green subfield period in each field.

Each of the gradation selecting circuits 77l to 77n of the gradation selecting circuit group 77 selects the two-gradation voltage signal inputted via the switch means 76 according to the display data of one bit of “0” or “1” inputted from the image memory 70, and outputs the signal as the data signal (driving voltage). The data signals (driving voltages) are applied to the signal electrodes 48l to 48n of the signal electrode group 48 to perform black-and-white display or monocolor display.

A boosting circuit 71 separately has a color driving voltage generating part 73 and a black-and-white driving voltage generating part 75. The color driving voltage generating part 73 generates the voltage V2 and the voltage −V2 having a reverse polarity thereto for generating the multi-gradation signal for use in the FSC drive and sends them to the multi-gradation signal generating circuit 72. The black-and-white driving voltage generating part 75 generates the voltage V1 and the voltage −V1 having a reverse polarity thereto for generating the two-gradation signal for use in the black-and-white display or the monocolor display and sends them to the two-gradation signal generating circuit 74.

The absolute value of the voltage V1 being the output of the black-and-white driving voltage generating part 75 is set smaller than the absolute value of the voltage V2 being the output of the color driving voltage generating part 73, thereby suppressing the power consumption during standby being the black-and-white display.

Note that the reason why to generate the positive and negative voltages V2 and −V2 and the positive and negative voltages V1 and −V1 is to reverse the polarity of the data signal (driving voltage) to be applied to the signal electrode group 48 between one and the other of two fields constituting one frame so as to prevent a direct voltage from being stored in the capacitors in the pixels of the liquid crystal display part.

In response to a color/black-and-white switch signal Sc indicating whether to perform the color display or the black-and-white (or monocolor) display, the switch means 76 selects one of the multi-gradation voltage signal inputted from the multi-gradation signal generating circuit 72 and the two-gradation signal inputted from the two-gradation signal generating circuit 74, and outputs the selected signal to the gradation selecting circuits 77l to 77n of the gradation selecting circuit group 77.

Further, by the color/black-and-white switch signal Sc, the operations of the image memory 70, the boosting circuit 71, the multi-gradation signal generating circuit 72, and the two-gradation signal generating circuit 74 are also switched concurrently with the switching of the switch means 76.

In other words, if the color/black-and-white switch signal Sc is, for example, “1” for color display, the switch means 76 switches to output the multi-gradation voltage signal, concurrently with which the image memory 70 operates to send display data for each color, each row, and each pixel individually to each of the gradation selecting circuits 77l to 77n of the gradation selecting circuit group 77 in synchronization with the write period of the subfield period of each color as described above, and the boosting circuit 71 operates only the color driving voltage generating part 73. Further, only the multi-gradation signal generating circuit 72 out of the multi-gradation signal generating circuit 72 and the two-gradation signal generating circuit 74 operates.

On the other hand, if the color/black-and-white switch signal Sc is, for example, “0” for the black-and-white or the monocolor display, the switch means 76 switches to output the two-gradation voltage signal, concurrently with which the image memory 70 operates to send only the most significant bit G3 of the display data for green individually to each of the gradation selecting circuits 77l to 77n of the gradation selecting circuit group 77 in synchronization with the green subfield period in each field as described above, and the boosting circuit 71 operates only the black-and-white driving voltage generating part 75. Further, only the two-gradation signal generating circuit 74 out of the multi-gradation signal generating circuit 72 and the two-gradation signal generating circuit 74 operates.

The color/black-and-white switch signal Sc is automatically generated depending on the state of the electronic equipment incorporating the liquid crystal display device, or generated by manual operation.

Conventionally, the driving voltage could not be changed because the same power source is used for the color display and the black-and-white display, but the color driving voltage generating part 73 and the black-and-white driving voltage generating part 75 are separately provided in this embodiment to enable the driving voltage during the black-and-white display or the monocolor display to be smaller than the driving voltage during the color display.

Further, since the power consumption of the multi-gradation signal generating circuit 72 and the boosting circuit 71 is large, the power consumption is suppressed by stopping the operation of the black-and-white driving voltage generating part 75 and the two-gradation signal generating circuit 74 during the color display, and by stopping the operation of the color driving voltage generating part 73 and the multi-gradation signal generating circuit 72 during the black-and-white display or the monocolor display, in response to the color/black-and-white switch signal Sc.

Since the power supply to either of the multi-gradation signal generating circuit 72 and the two-gradation signal generating circuit 74 is always stopped, the switch means 76 can also be composed of a wired OR circuit.

### EMBODIMENT 2

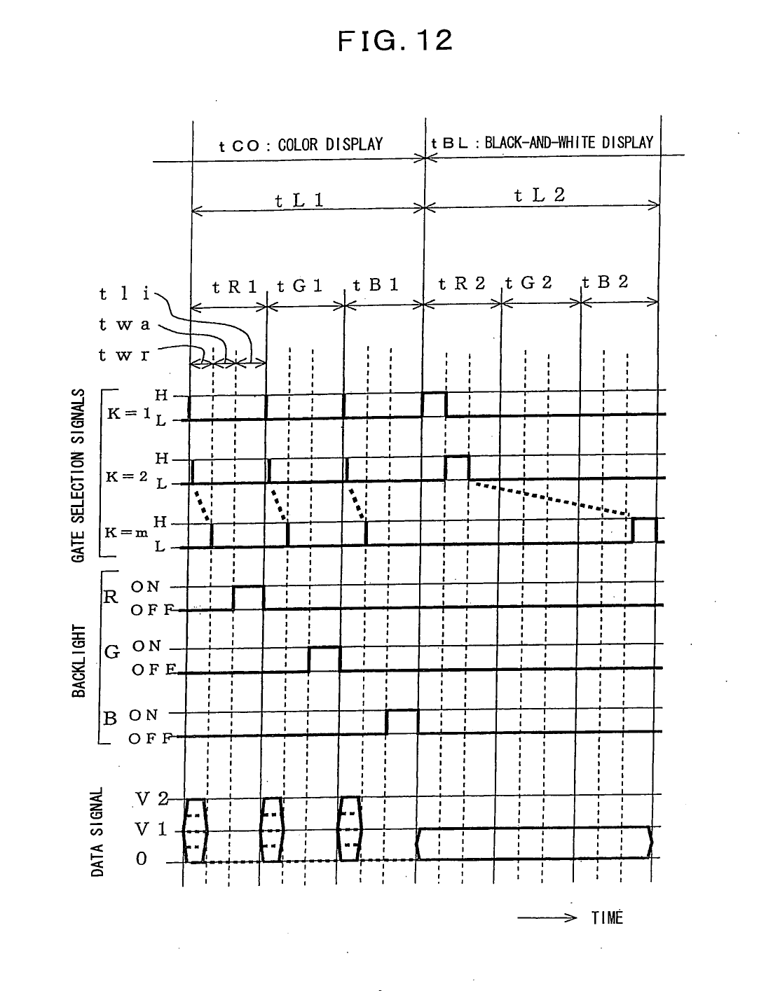

FIG. 12 is a timing chart showing the liquid crystal panel driving operation according to the second embodiment of the invention.

The different point of the timing chart of the second embodiment from that of the first embodiment is the gate selection signal during the black-and-white display.

During the black-and-white display or the monocolor display, the gate scanning electrode group 50 is selected during one subfield period in the first embodiment, whereas the gate scanning electrode group 50 is selected during the whole period of one field period tL2 over the subfield periods tR2, tG2, and tB2 divided as shown in the chart in the second embodiment. In this embodiment, the two-gradation signal corresponding to the most significant bit of the display data for green is supplied as the “data signal” during the black-and-white display. More specifically, the gate scanning electrodes of the gate scanning electrode group 50 are each selected once by the gate selection signals “K=1,” “K=2,” . . . “K=m.” As a result, the time during which one gate scanning electrode is selected, that is, the time of voltage application to the liquid crystal is about nine times that in the case of the FSC drive.

Further, during the FSC drive by the first driving circuit 2, the data signal is written into each pixel of the liquid crystal for each subfield to apply a new voltage, whereas during the black-and-white drive by the second driving circuit 3, a new voltage is applied for each field, resulting in a cycle of the voltage application that is three times as long as that during the FSC drive as in the first embodiment.

As described above, the time of voltage application to the liquid crystal during the black-and-white display is nine times and the cycle of the voltage application is three times as long as those during the FSC drive, so that the voltage V1 of the “data signal” during the black-and-white display can be made smaller in absolute value than in the case of the first embodiment, thus bringing about a remarkable effect of reduction in power consumption.

### EMBODIMENT 3

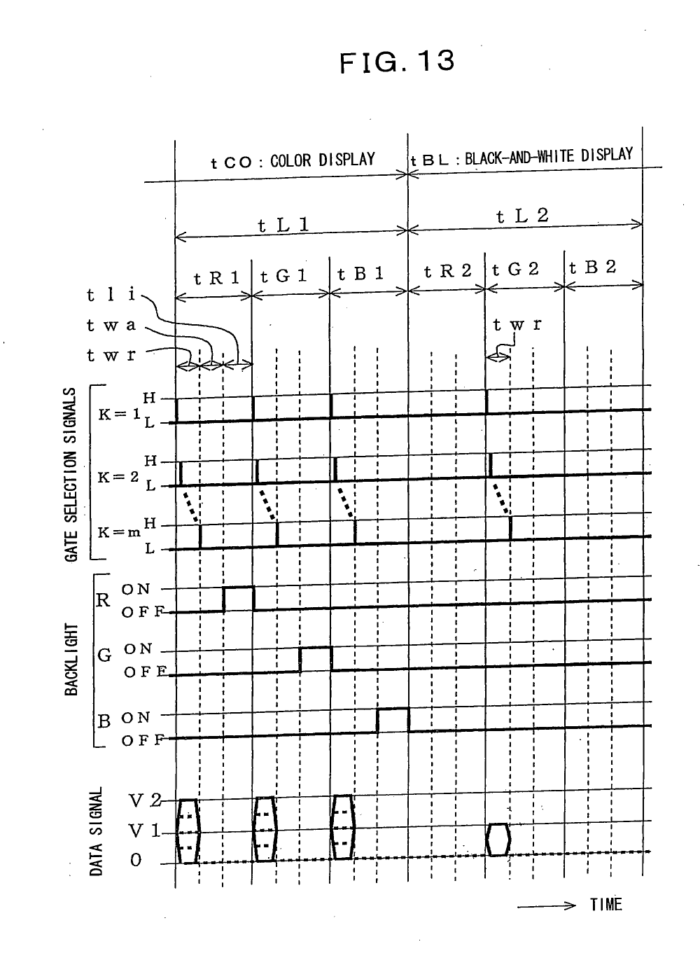

FIG. 13 is a timing chart showing the liquid crystal panel driving operation according to the third embodiment of the invention.

The different point of the timing chart of the third embodiment from that of the first embodiment is the gate selection signal during the black-and-white display.

During the black-and-white display or the monocolor display, the gate scanning electrode group 50 is selected only during one subfield period and during the whole period of that subfield in the first embodiment, whereas the gate scanning electrode group 50 is selected only during the write period of one subfield period as shown in the chart in the third embodiment. The green subfield tG2 is selected as the one subfield.

More specifically, the gate scanning electrodes of the gate scanning electrode group 50 are each selected once by the gate selection signals “K=1,” “K=2,” . . . “K=m” during the write period twr of the green subfield tG2.

As a result, the time during which one gate scanning electrode is selected, that is, the time of voltage application to the liquid crystal is the same as that in the case of the FSC drive, but the cycle of the voltage application is three times as long as that in the case of the FSC drive as in the first embodiment.

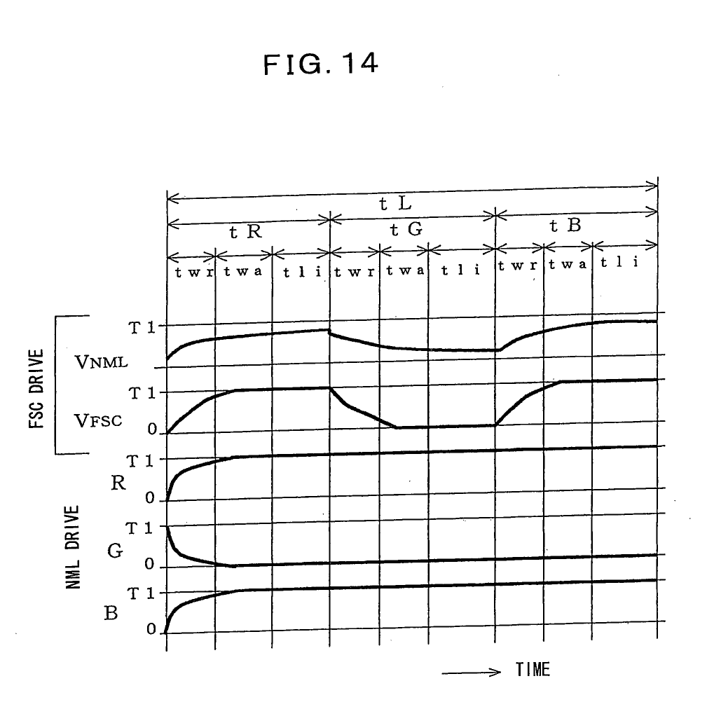

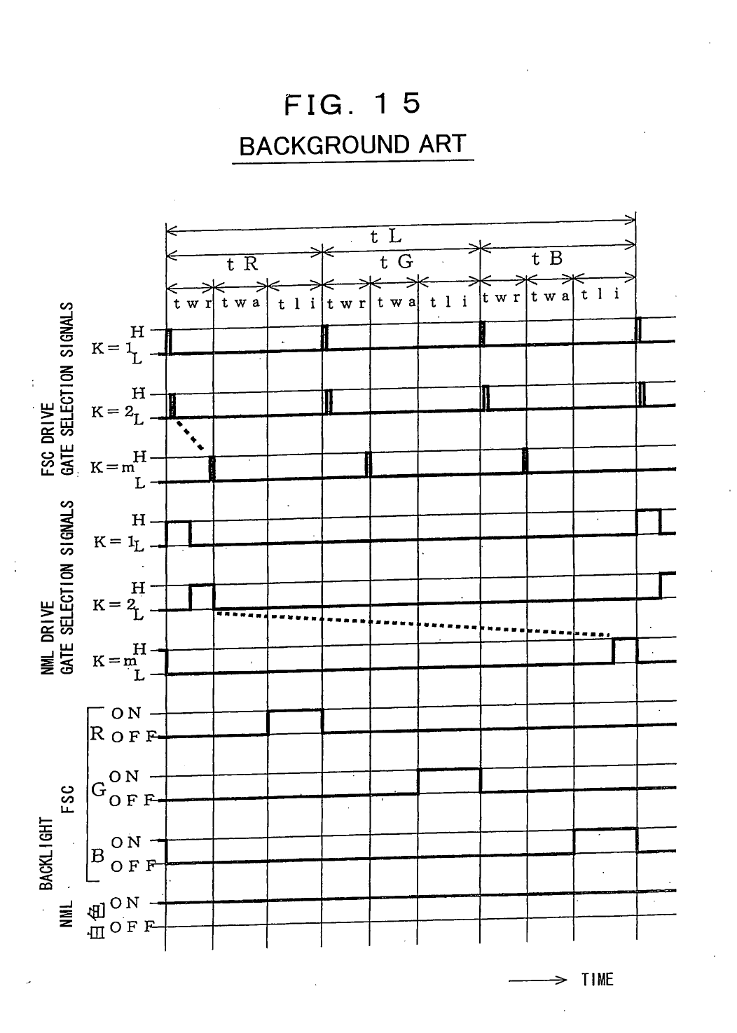

As described above, when the cycle of the voltage application is made longer, the voltage applied to the liquid crystal can be reduced even if the time of voltage application to the liquid crystal is the same. The reason will be described using FIG. 14.

FIG. 14 is a diagram showing a response of a liquid crystal pixel by the FSC drive and the NML drive. FIG. 14, in which the horizontal axis indicates time and the vertical axis indicates the transmittance of the liquid crystal, shows an example where the display data for red (R) and blue (B) show gradations when the transmittances of the liquid crystal are maximum, and the display data for green (G) shows the gradation when the transmittance of the liquid crystal is minimum. The “V_{NML}” shown in the FSC drive is the response characteristic of the liquid crystal when the same voltage as that in the case of the NML drive is applied, and the “V_{FSC}” shown in the FSC drive is the response characteristic of the liquid crystal when a voltage for the FSC drive higher than that voltage is applied.

R, G and B in the NML drive show the response characteristics of the red pixel, the green pixel and the blue pixel, respectively, and each of the response characteristics shown is of the pixel on the row of the liquid crystal display part which is selected first.

In the case of the FSC drive, the data for R, G, and B are applied to the same pixel in time sequence, so that the voltage applied to the liquid crystal varies according to the display data for each color for each subfield, even for a still image, except for the special case. On the other hand, in the NML drive, the voltage applied to each pixel does not vary unless the image is changed, so that the voltage applied to the liquid crystal varies for each field, that is, for each reversal of polarity of the driving voltage for each field.

Therefore, the transmittance of the liquid crystal is brought to a desired value during not one subfield but one field that is the time of three times the subfield during the black-and-white display, thereby avoiding the problem with display quality.

Further, since the time for selecting each row of the liquid crystal display panel is short in the case of the FSC drive, the application of the same voltage as that in the case of the NML drive often fails to reach the desired transmittance T1 in one subfield as shown at the “V_{NML}” in FIG. 14.

Since the time for selecting each row is long, the pixel capacitance is small, and the display data does not vary for each subfield in the NML drive, the desired transmittance T1 can be reached in the time of one field tL as shown at “R” and “B” in FIG. 14.

Hence, a voltage higher than the original voltage for displaying gradation is applied in the case of the FSC drive to increase the response speed of the liquid crystal as shown at “V_{NML}” in FIG. 14.

Therefore, during the black-and-white display in which the NML drive is performed, the liquid crystal can be driven by the voltage V1 having an absolute value smaller that that of the driving voltage V2 during the FSC drive.

During the black-and-white display, the cycle of the voltage application to the liquid crystal is three times as long as that during the FSC drive described above, so that the voltage V1 of the “data signal” during the black-and-white display can be significantly reduced, though not so much as in the first embodiment or the second embodiment, as compared to the FSC drive to bring about a sufficient effect of reduction in power consumption.

Further, the third embodiment can realize the black-and-white display just by switching the display data for green to the two-gradation signal, stopping the data write during the red and blue subfields tR2 and tB2 to turn off the backlights, thus constructing the electronic circuit in the control system in a very simple configuration to bring about a significantly great effect of reduction in cost of the electronic circuit.

Note that turning on the backlight of green or another color enables monocolor display of that single color and black.

### INDUSTRIAL APPLICABILITY

As has been described, the liquid crystal display device according to the invention is capable of both the color display and the black-and-white display or the monocolor display and can significantly reduce power consumption, and therefore it can be widely used as a display device installed in various kinds of portable electronic devices including cellular phone, portable digital assistant, portable liquid crystal television, mobile personal computer, and others.

1. A liquid crystal display device for forming a predetermined image on one screen by sequentially selecting a plurality of scanning lines and applying a voltage to a liquid crystal,
wherein the frequency for selecting the scanning line comprises at least two frequencies, said frequencies being a high frequency and a frequency lower than the high frequency, and
wherein a voltage applied to the liquid crystal at the low frequency is made lower than a voltage applied to the liquid crystal at the high frequency.

2. The liquid crystal display device according to claim 1,
wherein both of a first drive and a second drive are selectable, the first drive performing color display by applying driving voltages to the liquid crystal in synchronization with light emission timings of light source for sequentially emitting a plurality of light with different wavelengths in a predetermined cycle, and the second drive performing display by stopping the light emission by the light source or permitting the light source to emit only light of one wavelength to apply a driving voltage to the liquid crystal in a predetermined cycle, and wherein the first drive is at the high frequency and the second drive is at the low frequency.

3. A liquid crystal display device, comprising:
a liquid crystal display panel comprising a liquid crystal display part provided with no color filter and a backlight unit having light source capable of emitting light of a plurality of colors with different wavelengths;
a first driving circuit for performing color display by permitting the light source of the liquid crystal display panel to sequentially emit the light of the plurality of colors with different wavelengths in a predetermined cycle, and applying a driving voltage to a liquid crystal of each pixel of the liquid crystal display part in synchronization with the light emission timings;
a second driving circuit for performing black-and-white display or monocolor display by stopping the light emission by the light source or permitting the light source to emit only light of one wavelength to apply a driving voltage to the liquid crystal in each pixel of the liquid crystal display part in a cycle longer than the predetermined cycle; and
a drive selecting means for selecting and operating any one of the first driving circuit and the second driving circuit,
wherein the driving voltage by the second driving circuit is made smaller in absolute value than the driving voltage by the first driving circuit.

4. The liquid crystal display device according to claim 3,
wherein the first driving circuit is a circuit for performing field sequential color drive.

5. The liquid crystal display device according to claim 4,
wherein the time of application of the driving voltage to each pixel of the liquid crystal display part by the second driving circuit is made longer than the time of application of the driving voltage to each pixel of the liquid crystal display part by the first driving circuit.

6. The liquid crystal display device according to claim 4,
wherein during the field sequential color drive by the first driving circuit, one field of display by the liquid crystal display panel is divided at least into subfields corresponding to the number of colors of light emitted by the light source, and driving voltages according to display data for different colors are sequentially applied to each pixel of the liquid crystal display part for each of the subfields, and
wherein during the drive by the second driving circuit, a driving voltage according to display data is applied to each pixel of the liquid crystal display part only during a period corresponding to one subfield of the subfields to increase the cycle of application of the driving voltage or the application cycle and application time.

7. The liquid crystal display device according to claim 4,
wherein during the field sequential color drive by the first driving circuit, one field of display by the liquid crystal display panel is divided at least into subfields corresponding to the number of colors of light emitted by the light source, and each of the subfields is further divided into a write period to write display data into the liquid crystal display part, a response waiting period to wait for response by the liquid crystal display part, and a lighting period to permit the light source to emit light of a color corresponding to each subfield, and driving voltages according to display data for different colors are sequentially applied to each pixel of the liquid crystal display part only during each said write period for each said subfield, and
wherein during the drive by the second driving circuit, a driving voltage according to display data is applied to each pixel of the liquid crystal display part only during a period corresponding to the write period of one subfield of the subfields to increase the cycle of application of the driving voltage.

8. The liquid crystal display device according to claim 5,
wherein during the field sequential color drive by the first driving circuit, one field of display by the liquid crystal display panel is divided into subfields corresponding to the number of colors of light emitted by the light source, and driving voltages according to display data for different colors are sequentially applied to each pixel of the liquid crystal display part for each of the subfields, and
wherein during the drive by the second driving circuit, a driving voltage according to display data is applied to each pixel of the liquid crystal display part over a plurality of the divided subfield periods to increase the cycle and time of application of the driving voltage.

9. The liquid crystal display device according to claim 4,
wherein the display data generating the driving voltage during the drive by the second driving circuit is data corresponding to the most significant bit of the color corresponding to the selected subfield or a specific color.

10. The liquid crystal display device according to claim 9,
wherein the color corresponding to the selected subfield or the specific color is green.

11. The liquid crystal display device according to claim,
wherein the first driving circuit is provided with a multi-gradation signal generating circuit for three gradations or more, and during the field sequential color drive, the driving voltage generated by the multi-gradation signal generating circuit according to display data is applied to each pixel of the liquid crystal display part, and
wherein the second driving circuit is provided with a two-gradation signal generating circuit, and during the drive by the second driving circuit, the multi-gradation signal generating circuit is stopped, and the driving voltage generated by the two-gradation signal generating circuit is applied to each pixel of the liquid crystal display part.

12. The liquid crystal display device according to claim 11,
wherein the driving voltage generated by the two-gradation signal generating circuit is smaller in absolute value of voltage than the driving voltage generated by the multi-gradation signal generating circuit.

13. The liquid crystal display device according to claim 12,
wherein a color driving voltage generating part and a black-and-white driving voltage generating part are provided so that an output voltage of the color driving voltage generating part is supplied to the multi-gradation signal generating circuit, and an output voltage of the black-and-white driving voltage generating part is supplied to the two-gradation signal generating circuit, and wherein the output voltage of the black-and-white driving voltage generating part is set smaller in absolute value than the output voltage of the color driving voltage generating part.

14. The liquid crystal display device according to claim 3,
wherein the driving voltage by the second driving circuit is made smaller by 15% to 70% in absolute value than the driving voltage by the first driving circuit.

15. The liquid crystal display device according to claim 5,
wherein during the field sequential color drive by the first driving circuit, one field of display by the liquid crystal display panel is divided at least into subfields corresponding to the number of colors of light emitted by the light source, and driving voltages according to display data for different colors are sequentially applied to each pixel of the liquid crystal display part for each of the subfields, and
wherein during the drive by the second driving circuit, a driving voltage according to display data is applied to each pixel of the liquid crystal display part only during a period corresponding to one subfield of the subfields to increase the cycle of application of the driving voltage or the application cycle and application time.

16. The liquid crystal display device according to claim 5,
wherein during the field sequential color drive by the first driving circuit, one field of display by the liquid crystal display panel is divided at least into subfields corresponding to the number of colors of light emitted by the light source, and each of the subfields is further divided into a write period to write display data into the liquid crystal display part, a response waiting period to wait for response by the liquid crystal display part, and a lighting period to permit the light source to emit light of a color corresponding to each subfield, and driving voltages according to display data for different colors are sequentially applied to each pixel of the liquid crystal display part only during each said write period for each said subfield, and
wherein during the drive by the second driving circuit, a driving voltage according to display data is applied to each pixel of the liquid crystal display part only during a period corresponding to the write period of one subfield of the subfields to increase the cycle of application of the driving voltage.

17. The liquid crystal display device according to claim 5,
wherein the display data generating the driving voltage during the drive by the second driving circuit is data corresponding to the most significant bit of the color corresponding to the selected subfield or a specific color.

18. The liquid crystal display device according to claim 5,
wherein the first driving circuit is provided with a multi-gradation signal generating circuit for three gradations or more, and during the field sequential color drive, the driving voltage generated by the multi-gradation signal generating circuit according to display data is applied to each pixel of the liquid crystal display part, and
wherein the second driving circuit is provided with a two-gradation signal generating circuit, and during the drive by the second driving circuit, the multi-gradation signal generating circuit is stopped, and the driving voltage generated by the two-gradation signal generating circuit is applied to each pixel of the liquid crystal display part.

19. The liquid crystal display device according to claim 18,
wherein a color driving voltage generating part and a black-and-white driving voltage generating part are provided so that an output voltage of the color driving voltage generating part is supplied to the multi-gradation signal generating circuit, and an output voltage of the black-and-white driving voltage generating part is supplied to the two-gradation signal generating circuit, and wherein the output voltage of the black-and-white driving voltage generating part is set smaller in absolute value than the output voltage of the color driving voltage generating part.

20. The liquid crystal display device according to claim 4,
wherein the driving voltage by the second driving circuit is made smaller by 15% to 70% in absolute value than the driving voltage by the first driving circuit.
